(19) United States
(12) Patent Application Publication
(10) Pub. No.: US 2024/0192335 A1
(43) Pub. Date: Jun. 13, 2024

(54) DISTANCE IMAGE CAPTURING DEVICE AND DISTANCE IMAGE CAPTURING METHOD

(71) Applicant: TOPPAN Holdings Inc., Tokyo (JP)

(72) Inventors: Kunihiro HATAKEYAMA, Tokyo (JP); Hiromitsu HARIU, Tokyo (JP)

(73) Assignee: TOPPAN Holdings Inc., Tokyo (JP)

(21) Appl. No.: 18/534,094

(22) Filed: Dec. 8, 2023

(30) Foreign Application Priority Data
Dec. 13, 2022 (JP) 2022-198729
Oct. 20, 2023 (JP) 2023-181212

(51) Int. Cl. G01S 7/4863; G01S 17/894

(52) U.S. Cl. CPC G01S 7/4863; G01S 17/894

(57) ABSTRACT

A distance image capturing device includes a distance image processing unit, that drives pixels with three driving patterns consisting of a first pattern, a second pattern, and a third pattern, calculates a flare light reception timing at which flare light is received in the first pattern, controls an emission timing such that the flare light reception timing and a gate opening and closing timing are the same timing, in the second pattern, controls such that an emission period is shorter than an emission period in the second pattern, in the third pattern, and calculates a flare signal amount corresponding to a light amount of the flare light received by a pixel, by using a subtraction value obtained by subtracting a storage signal in the third pattern from a storage signal in the second pattern to calculate a distance to an object by using the calculated flare signal amount.

### BACKGROUND OF THE INVENTION

### Field of the Invention

The present invention relates to a distance image capturing device and a distance image capturing method.

Priority is claimed on Japanese Patent Application No. 2022-198729, filed Dec. 13, 2022, and Japanese Patent Application No. 2023-181212, filed Oct. 20, 2023, the contents of which are incorporated herein by reference.

### Description of Related Art

In the related art, a time of flight (hereinafter, referred to as “TOF”) type distance image sensor has been implemented that uses a known speed of light and measures a distance between a measuring instrument and an object based on a flight time of light in space (measurement space) (see, for example, Patent Document 1: Japanese Patent No. 4235729).

In a case where an attempt is made to simultaneously capture images of an object existing in the short distance and an object existing in the far distance by using the TOF type distance image capturing device, the reflected light from the object existing in the short distance is received with a higher light intensity than the reflected light from the object existing in the far distance. In that case, since multiple reflections called the flare phenomenon occur in an optical system such as a lens provided in the distance image capturing device, the reflected light from the object existing in the short distance is superimposed on the pixel that receives the reflected light from the object existing in the far distance, and thus it is difficult to accurately measure the distance. Reducing means for making it difficult for the flare phenomenon to occur by devising a driving method is disclosed (see, for example, Patent Document 2: Japanese Unexamined Patent Application, First Publication No. 2020-197422).

Furthermore, there are also other discloses, such as Patent Document 3: PCT International Publication No. WO2021/020496.

### SUMMARY OF THE INVENTION

However, in Patent Document 2, there is a problem that four equations are generated and parameters are required to be obtained such that each equation becomes 0, which leads to a problem of an increase in calculation cost.

The present invention has been made in view of such circumstances, and provides a distance image capturing device and a distance image capturing method capable of subtracting an amount of light received by the flare phenomenon without increasing a calculation cost.

In order to solve the above-described problem, a distance image capturing device of the present invention includes: a light source unit that irradiates a space to be measured with an optical pulse; a light receiving unit having a pixel including a photoelectric conversion element that generates charges according to light incident from the space to be measured and a plurality of charge storage units that store the charges, and a pixel drive circuit that performs driving of storing the charges in each of the charge storage units; and a distance image processing unit that controls the pixel drive circuit such that the charges are distributed to the charge storage units and stored in each of the charge storage units at a storage timing synchronized with an emission timing of emitting the optical pulse, and calculates a distance to an object based on an amount of charges stored in each of the charge storage units, in which the distance image processing unit drives the pixel with three driving patterns consisting of a first pattern, a second pattern, and a third pattern, calculates a flare light reception timing at which flare light is received, based on a storage signal corresponding to the amount of charges stored in each of the charge storage units of the pixel, in the first pattern, controls the emission timing such that the flare light reception timing and an opening and closing timing of a first gate for storing the charges in a first charge storage unit among the charge storage units in the pixel are the same timing, in the second pattern, performs control such that an emission period of emitting the optical pulse is shorter than an emission period in the second pattern, in the third pattern, and calculates a flare signal amount corresponding to a light amount of the flare light received by the pixel, by using a subtraction value obtained by subtracting the storage signal in the third pattern from the storage signal in the second pattern to calculate the distance to the object by using the calculated flare signal amount.

A distance image capturing method according to the present invention is performed by a distance image capturing device including a light source unit that irradiates a space to be measured with an optical pulse, a light receiving unit having a pixel including a photoelectric conversion element that generates charges according to light incident from the space to be measured and a plurality of charge storage units that store the charges, and a pixel drive circuit that performs driving of storing the charges in each of the charge storage units, and a distance image processing unit that controls the pixel drive circuit such that the charges are distributed to the charge storage units and stored in each of the charge storage units at a storage timing synchronized with an emission timing of emitting the optical pulse, and calculates a distance to an object based on an amount of charges stored in each of the charge storage units, the method including: via the distance image processing unit, driving the pixel with three driving patterns consisting of a first pattern, a second pattern, and a third pattern; calculating a flare light reception timing at which flare light is received, based on a storage signal corresponding to the amount of charges stored in each of the charge storage units of the pixel, in the first pattern; controlling the emission timing such that the flare light reception timing and an opening and closing timing of a first gate for storing the charges in a first charge storage unit among the charge storage units in the pixel are the same timing, in the second pattern; performing control such that an emission period of emitting the optical pulse is shorter than an emission period in the second pattern, in the third pattern; and calculating a flare signal amount corresponding to a light amount of the flare light received by the pixel, by using a subtraction value obtained by subtracting the storage signal in the third pattern from the storage signal in the second pattern to calculate the distance to the object by using the calculated flare signal amount.

As described above, according to the present invention, it is possible to subtract the amount of light received by the flare phenomenon without increasing the calculation cost.

### BRIEF DESCRIPTION OF THE DRAWINGS

FIG. 1 is a block diagram showing a configuration example of a distance image capturing device 1 according to an embodiment.

FIG. 2 is a block diagram showing a configuration example of a distance image sensor 32 according to the embodiment.

FIG. 3 is a circuit diagram showing a configuration example of a pixel 321 according to the embodiment.

FIG. 4A is a diagram for explaining the flare phenomenon.

FIG. 4B is a diagram for explaining the flare phenomenon.

FIG. 5A is a diagram for describing a process performed by a distance image capturing device 1 according to the embodiment.

FIG. 5B is a diagram for describing the process performed by the distance image capturing device 1 according to the embodiment.

FIG. 5C is a diagram for describing the process performed by the distance image capturing device 1 according to the embodiment.

FIG. 5D is a diagram for describing the process performed by the distance image capturing device 1 according to the embodiment.

FIG. 6 is a flowchart showing a flow of the process performed by the distance image processing unit 4 according to the embodiment.

FIG. 7A is a diagram for describing the process performed by a distance image capturing device 1 according to the embodiment.

FIG. 7B is a diagram for describing the process performed by a distance image capturing device 1 according to the embodiment.

FIG. 7C is a diagram for describing the process performed by a distance image capturing device 1 according to the embodiment.

FIG. 8A is a diagram for describing the process performed by a distance image capturing device 1 according to the embodiment.

FIG. 8B is a diagram for describing the process performed by a distance image capturing device 1 according to the embodiment.

FIG. 8C is a diagram for describing the process performed by a distance image capturing device 1 according to the embodiment.

FIG. 9 is a diagram for describing the process performed by the distance image capturing device 1 according to Modification Example 1 of the embodiment.

FIG. 10 is a diagram for describing the process performed by the distance image capturing device 1 according to Modification Example 2 of the embodiment.

FIG. 11 is a diagram for describing the process performed by the distance image capturing device 1 according to Modification Example 3 of the embodiment.

FIG. 12 is a diagram showing an example of a look-up table (LUT) according to Modification Example 3 of the embodiment.

FIG. 13 is a flowchart showing a flow of the process performed by the distance image processing unit 4 according to Modification Example 3 of the embodiment.

### DETAILED DESCRIPTION OF THE INVENTION

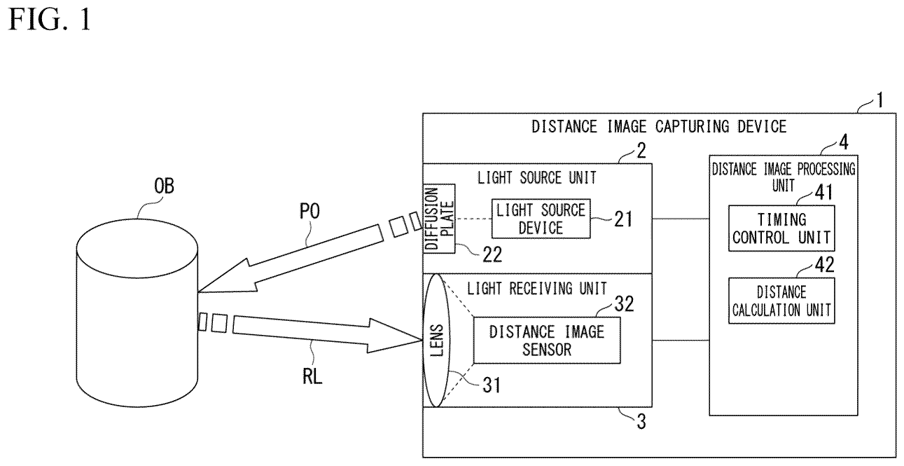

Hereinafter, an embodiment of the present invention will be described with reference to the drawings. FIG. 1 is a block diagram showing a configuration example of a distance image capturing device 1. The distance image capturing device 1 includes, for example, a light source unit 2, a light receiving unit 3, and a distance image processing unit 4. Further, FIG. 1 also shows an object OB to which a distance is to be measured by the distance image capturing device 1. The distance image capturing element is, for example, a distance image sensor 32 (described later) in the light receiving unit 3.

The light source unit 2 emits an optical pulse PO to a space-to-be-captured in which the object OB to which a distance is to be measured by the distance image capturing device 1 exists, in accordance with the control from the distance image processing unit 4. The light source unit 2 is, for example, a surface emitting semiconductor laser module such as a vertical cavity surface emitting laser (VCSEL). The light source unit 2 includes a light source device 21 and a diffusion plate 22.

A light source device 21 is a light source that emits laser light in a near-infrared wavelength band (for example, a wavelength band with a wavelength of 850 nm to 940 nm) as the optical pulse PO that emits the object OB. The light source device 21 is, for example, a semiconductor laser light emitting element. The light source device 21 emits pulsed laser light in accordance with the control of a timing control unit 41. The diffusion plate 22 is an optical component that diffuses the laser light of the near-infrared wavelength band emitted by the light source device 21 to a size of an irradiation surface of the object OB. The pulsed laser light diffused by the diffusion plate 22 is emitted as the optical pulse PO, and emitted into the object OB.

The light receiving unit 3 receives reflected light R L of the optical pulse PO reflected by the object OB of which a distance is to be measured in the distance image capturing device 1, and outputs a pixel signal corresponding to the received reflected light R L. The light receiving unit 3 includes a lens 31 and a distance image sensor 32. The lens 31 is an optical lens that guides the incident reflected light RL to the distance image sensor 32. The lens 31 emits the incident reflected light RL to the distance image sensor 32 side, and causes the pixel circuit provided in the light-receiving region of the distance image sensor 32 to receive (incident) the light.

The distance image sensor 32 is an image capturing element used in the distance image capturing device 1. The distance image sensor 32 includes a plurality of pixels in a two-dimensional light-receiving region. Each pixel circuit (pixel 321) of the distance image sensor 32 includes one photoelectric conversion element, a plurality of charge storage units corresponding to the one photoelectric conversion element, and a component that distributes charges to the charge storage units.

The distance image sensor 32 distributes the charges generated by the photoelectric conversion element to each of the charge storage units, according to control from the timing control unit 41. In addition, the distance image sensor 32 outputs pixel signals corresponding to the charge amounts distributed to the charge storage units. In the distance image sensor 32, a plurality of pixel circuits are arranged in a two-dimensional matrix, and pixel signals for one frame corresponding to each of the pixel circuits are output.

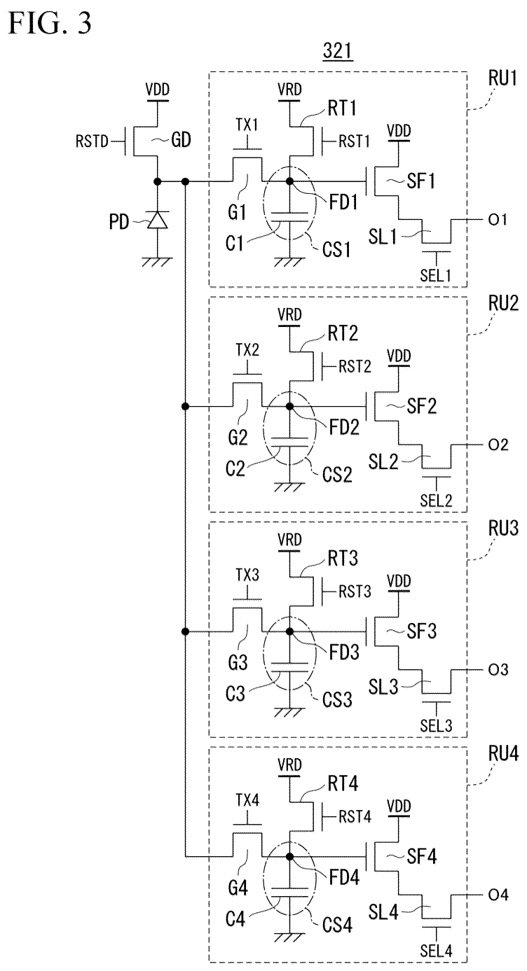

The distance image processing unit 4 controls the distance image capturing device 1, and calculates a distance to the object OB. The distance image processing unit 4 includes a timing control unit 41 and a distance calculation unit 42. The timing control unit 41 controls the timing of outputting various control signals required for measurement of a distance. Examples of the various control signals herein include a signal that controls the emission of the optical pulse PO, a signal that distributes the reflected light RL to the plurality of charge storage units, a signal that discharges charges to prevent light such as background light received by the light receiving unit 3 from being stored in the charge storage units, and a signal that controls the number of times of distribution per frame. The number of times of distribution is the number of times the process of distributing charges to the charge storage units CS (see FIG. 3) is repeated.

The distance calculation unit 42 outputs distance information obtained by calculating the distance to the object OB based on the pixel signal output from the distance image sensor 32. The distance calculation unit 42 calculates a delay time Td from emitting the optical pulse PO to receiving the reflected light RL, based on the amount of charges stored in the plurality of charge storage units CS. The distance calculation unit 42 calculates the distance to the object OB from the distance image capturing device 1 in accordance with the calculated delay time Td.

With such a configuration, in the distance image capturing device 1, the light receiving unit 3 receives the reflected light RL in which the optical pulse PO in the near-infrared wavelength band emitted to the object OB by the light source unit 2 is reflected by the object OB, and the distance image processing unit 4 outputs the distance information obtained by measuring the distance between the object OB and the distance image capturing device 1. Although FIG. 1 shows the distance image capturing device 1 having a configuration in which the distance image processing unit 4 is provided inside, the distance image processing unit 4 may be a component provided outside the distance image capturing device 1.

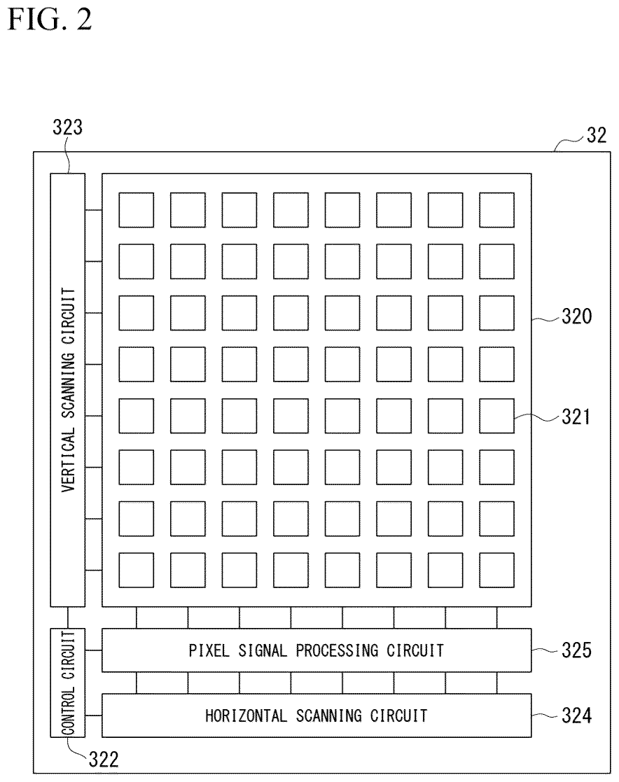

Next, the configuration of the distance image sensor 32 used as the image capturing element in the distance image capturing device 1 will be described. FIG. 2 is a block diagram showing a configuration example of an image capturing element (distance image sensor 32). As shown in FIG. 2, the distance image sensor 32 includes, for example, a light-receiving region 320 in which a plurality of pixels 321 are arranged, a control circuit 322, a vertical scanning circuit 323 performing a distribution operation, a horizontal scanning circuit 324, and a pixel signal processing circuit 325.

The light-receiving region 320 is a region in which a plurality of pixels 321 are arranged, and FIG. 2 shows an example in which the plurality of pixels 321 are arranged in a two-dimensional matrix in eight rows and eight columns. The pixels 321 store charges corresponding to the amount of light received. For example, the control circuit 322 controls the operations of the components of the distance image sensor 32 in response to an instruction from the timing control unit 41 of the distance image processing unit 4.

The vertical scanning circuit 323 is a circuit that controls the pixels 321 arranged in the light-receiving region 320 for each row according to the control from the control circuit 322. The vertical scanning circuit 323 outputs a voltage signal corresponding to the amount of charges stored in each of the charge storage units CS of the pixel 321 to the pixel signal processing circuit 325.

The pixel signal processing circuit 325 performs a predetermined signal process (for example, a noise suppression process, an A/D conversion process, or the like) on the voltage signal output from the pixel 321 in each of the columns in accordance with the control from the control circuit 322. The horizontal scanning circuit 324 is a circuit that outputs the signals output from the pixel signal processing circuit 325 in time series in accordance with the control from the control circuit 322. Accordingly, a pixel signal corresponding to the amount of charges stored for one frame is sequentially output to the distance image processing unit 4. In the following description, it is assumed that the pixel signal processing circuit 325 performs an A/D conversion process and the pixel signal is a digital signal.

Here, the configuration of the pixels 321 arranged in the light-receiving region 320 provided in the distance image sensor 32 will be described. FIG. 3 is a circuit diagram showing a configuration example of the pixel 321. The pixel 321 in FIG. 3 is a configuration example including four pixel signal readout units.

The pixel 321 includes one photoelectric conversion element PD, charge discharge transistors GD (GD1 and GD2 which will be described later), and four pixel signal readout units RU (RU1 to RU4) that output voltage signals from corresponding output terminals O. Each of the pixel signal readout units RU includes a charge transfer transistor G, a floating diffusion FD, a charge storage capacitor C, a reset transistor RT, a source follower transistor SF, and a selection transistor SL. The floating diffusion FD and the charge storage capacitor C configure a charge storage unit CS.

In the pixel 321 shown in FIG. 3, a pixel signal readout unit RU1 that outputs a voltage signal from an output terminal O1 includes a charge transfer transistor G1 (transfer MOS transistor), a floating diffusion FD1, a charge storage capacitor C1, a reset transistor RT1, a source follower transistor SF1, and a selection transistor SL1. In the pixel signal readout unit RU1, the charge storage unit CS1 is composed of the floating diffusion FD1 and the charge storage capacitor C1. Pixel signal readout units RU2, RU3, and RU4 also have the same configuration.

The photoelectric conversion element PD is an embedded photodiode that photoelectrically converts incident light to generate a charge corresponding to the input light (incident light), and stores the generated charge. In the present embodiment, the incident light is incident from the space to be measured. In the pixel 321, the charges generated by photoelectric conversion of incident light by the photoelectric conversion element PD are distributed to four charge storage units CS (CS1 to CS4), and each of the voltage signals corresponding to the charge amount of the distributed charges is output to the pixel signal processing circuit 325.

In addition, the configuration of the pixel 321 is not limited to the configuration including four pixel signal readout units RU (RU1 to RU4) as shown in FIG. 3. The pixel 321 may be, for example, a pixel circuit having a configuration including a plurality of 2M (M is an integer, M≥2) or more pixel signal readout units RU. That is, the pixel circuit may have a configuration including 2M (M is an integer, M≥2) or more charge transfer transistors G.

In addition, the configuration of the pixel 321 is not limited to the configuration including the charge discharge transistor GD (GD1 and GD2 which will be described later) as shown in FIG. 3. The pixel 321 may be, for example, a pixel circuit having a configuration including a plurality of 2N (N is an integer, N≥1) or more charge discharge transistors GD.

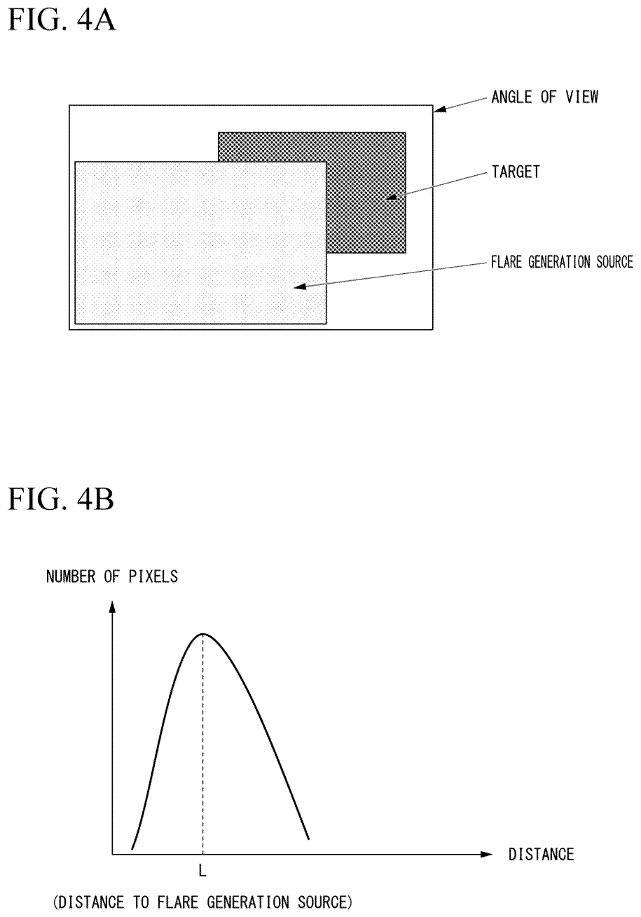

Here, the flare phenomenon will be described with reference to FIG. 4 (FIGS. 4A and 4B). FIG. 4 is a diagram for explaining the flare phenomenon.

FIG. 4A schematically shows a state in which two objects OB are present in an angle of view for distance image capturing. As shown in an example FIG. 4A, in distance image capturing, two objects OB of an object to be measured (target object OB1) and an object that can be a flare generation source (flare generation source object OB2) may be captured. The object that can be the flare generation source here is an object that reflects the reflected light having a high light intensity, and is, for example, a retroreflective object such as a sign, an object that exists at a short distance from the distance image capturing device 1, or an object with a high reflectance such as a white wall or a mirror.

In such a case, the pixel 321 that receives reflected light RL (target light) from the target object OB1 may receive the flare light coming from the flare generation source. In a case where such flare light is received, the amount of light to be received is larger than that in a case where only the target light is received, which causes an error to occur in the measurement of a distance to the target object OB1 calculated based on the amount of light received by the pixel 321.

FIG. 4B shows a histogram showing a correspondence relationship between the distance calculated in each pixel and the number of pixels 321 corresponding to the distance in a case where the distance to the object that can be the flare generation source is measured. The horizontal axis in FIG. 4B indicates the distance, and the vertical axis indicates the number of pixels.

As shown in the example in FIG. 4B, when an image is captured of an object that can be a flare generation source, the number of pixels corresponding to the distance L reaches a peak. It is considered that a pixel corresponding to the distance L corresponds to the pixel 321 that has received the flare light as the reflected light from the measurement target object.

In addition, when an image of an object that can be a flare generation source is captured, the number of pixels indicating the distance in the vicinity of the distance L tends to increase as the distance approaches the distance L. This can be considered that the distance including an error is calculated due to the reception of the flare light that should not be received.

In the present embodiment, it is possible to subtract a signal amount corresponding to the light amount of the flare light received by the pixel 321, from the storage signal of the pixel 321 that has received the flare light that should not be received. Hereinafter, a process (hereinafter, referred to as a flare suppression process) of subtracting a signal amount corresponding to a light amount of flare light received by the pixel 321 from the storage signal of the pixel 321 will be described.

First, it is assumed that flare light to be subjected to the flare suppression process has the following two properties.
(1) the flare light being received at a timing earlier than the timing of the target light
(2) a difference between light reception timings of the flare light and the target light being 1 clock or more

As shown in (1) described above, in the present embodiment, it is assumed that an object that can be a flare generation source is present at a position closer to the distance image capturing device 1 than the target object OB.

The clock in (2) described above is a periodic signal used to synchronize timings at which the distance image processing unit 4 performs various types of processes. For example, when the clock frequency is 500 [MHz] and the emission period for emitting the optical pulse PO is 16 [ns], the distance image processing unit 4 controls the emission period to be a period corresponding to 8 clocks. In this case, as (2), it is assumed that a difference between the light reception timings of the flare light and the target light is 1 clock or more, that is, 2 [ns] or more.

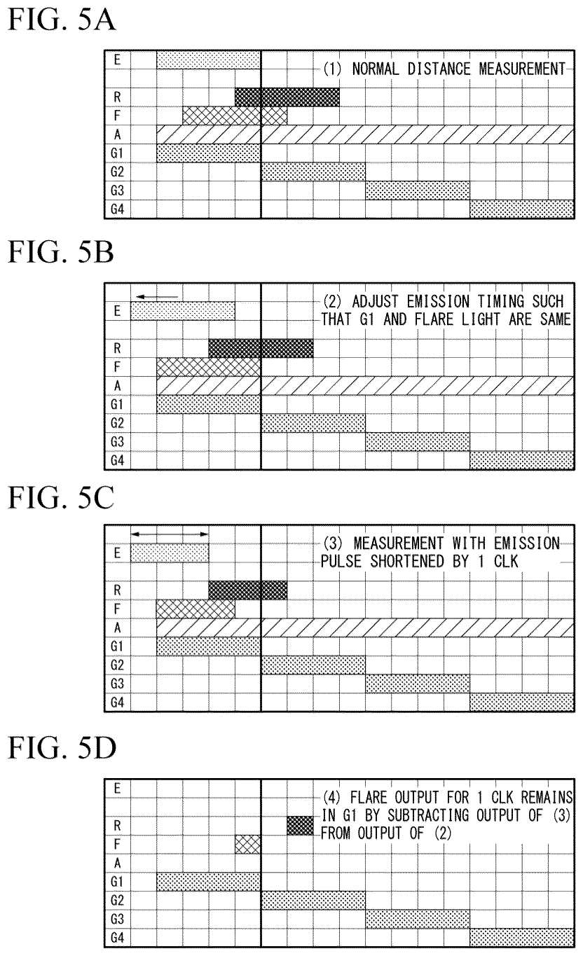

Here, a flare suppression process will be described with reference to FIG. 5 (FIGS. 5A to 5D). FIG. 5 is a diagram for describing the process performed by the distance image capturing device 1 according to the embodiment.

FIG. 5 (FIGS. 5A to 5D) schematically show timing charts showing timings for driving the pixel 321.

In FIGS. 5, an emission timing E for emitting the optical pulse PO is shown in the field “E”. A reflected light reception timing R for receiving target light is shown in the field “R”. In addition, the flare light reception timing F for receiving the flare light is shown in the field of “F”. A background light reception timing A for receiving the background light is shown in the field “A”.

In addition, a gate opening and closing timing G1 of the charge transfer transistor G1 that stores the charge in the charge storage unit CS1 is shown in the field of “G1”. A gate opening and closing timing G2 of the charge transfer transistor G2 that stores the charge in the charge storage unit CS2 is shown in the field of “G2”. A gate opening and closing timing G3 of the charge transfer transistor G3 that stores the charge in the charge storage unit CS3 is shown in the field of “G3”. A gate opening and closing timing G4 of the charge transfer transistor G4 that stores the charge in the charge storage unit CS4 is shown in the field of “G4”.

Further, in FIGS. 5, a period corresponding to 1 clock is shown to correspond to one square.

Three driving patterns (a first pattern, a second pattern, and a third pattern) are shown in FIG. 5. FIG. 5A shows an example of driving in the first pattern. FIG. 5B shows an example of driving in the second pattern. FIG. 5C shows an example of driving in the third pattern. The first pattern is the same driving timing as in the normal distance measurement that is not the flare suppression process. The second pattern and the third pattern are driving timings performed in a case where the flare suppression process is executed.

First, as shown in FIG. 5A, in the first pattern, the distance image processing unit 4 performs the same driving as in the normal distance measurement without the flare suppression process. In the example shown in FIG. 5A, in the normal distance measurement, the emission period for emitting the optical pulse PO is a period corresponding to 4 clocks.

In the first pattern, it is determined whether or not the pixel 321 is affected by flare light, that is, whether or not an object that reflects the reflected light having a high light intensity that can be a flare generation source, for example, an object existing in a short distance, a retroreflective object, an object having a high reflectance, or the like is present in the measurement space. In the driving in the first pattern, it is assumed that the reflected light having a high light intensity is received, so that the number of times of distribution per frame may be smaller than in the normal distance measurement.

In the example of FIG. 5A, the reflected light reception timing R arrives after a period corresponding to 3 clocks from the emission timing E, and the target light is received. In addition, the flare light reception timing F arrives after a period corresponding to 1 clock from the emission timing E, and the flare light is received. In addition, the background light is constantly received.

In addition, in the example of FIG. 5A, the distance image processing unit 4 controls the gate opening and closing timing G1 to be in the ON state at the same timing as the emission timing E for a period corresponding to the same 4 clocks as the emission period. After that, the distance image processing unit 4 sequentially controls each of the gate opening and closing timings G2 to G4 to be in the ON state in a period corresponding to the same 4 clocks as the emission period.

In this way, the distance image processing unit 4 drives the pixels 321 for one frame at the same timing as for normal distance measurement, and acquires a storage signal corresponding to the charges stored in each of the pixels 321. The distance image processing unit 4 calculates a distance from the acquired storage signal, and determines whether or not the pixel is affected by flare light, based on statistics indicating a correspondence relationship between the calculated distance and the number of pixels. For example, the distance image processing unit 4 generates a histogram showing the correspondence relationship between the calculated distance and the number of pixels.

For example, when the histogram shows a tendency of a mountain-shaped distribution that gradually increases toward a peak, that is, a tendency as shown in FIG. 4B, the distance image processing unit 4 determines that the pixel is affected by flare light.

On the other hand, the distance image processing unit 4 determines that the pixel is not affected by flare light, in a case where the histogram has a peak and the distribution of the number of pixels tends to change sharply like a delta function, for example, and differs from the mountain-shaped distribution in which the number of pixels gradually increases toward the peak.

In addition, the distance image processing unit 4 may determine whether or not the pixel is affected by the flare light, by using statistics indicating the correspondence relationship between the distance and the pixel, for example, a median value, a mean value, a variance, a standard deviation, and the like, instead of generating a histogram.

For example, the distance image processing unit 4 determines whether or not each of the pixels 321 includes a storage signal exceeding a predetermined threshold value per unit time. In a case where the pixel 321 includes the storage signal exceeding the threshold value, the distance image processing unit 4 calculates the distance corresponding to the pixel 321. Then, the distance image processing unit 4 determines whether or not the pixel is affected by flare light, based on a histogram showing the correspondence relationship between the calculated distance and the number of pixels. Alternatively, the distance image processing unit 4 determines whether or not the pixel is affected by the flare light based on statistics indicating a correspondence relationship between the calculated distance and the number of pixels.

When it is determined that the pixel is affected by the flare light, the distance image processing unit 4 executes the flare suppression process. When the flare suppression process is executed, the distance image processing unit 4 calculates a flare light reception timing F in the normal distance measurement shown in FIG. 5A. The distance image processing unit 4 calculates, for example, the timing at which the reflected light RL (flare light) is received by the pixel 321 corresponding to the distance indicating a peak in the histogram as the flare light reception timing F.

On the other hand, when it is determined that the pixel is not affected by the flare light, the distance image processing unit 4 performs a normal distance measurement.

When performing the flare suppression process, the distance image processing unit 4 performs the driving in the second pattern. In the second pattern, the distance image processing unit 4 adjusts the emission timing E such that the flare light reception timing F and the gate opening and closing timing G1 are the same timing, and controls the emission timing E to become earlier than in the first pattern.

As shown in the example in FIG. 5B, in the second pattern, for example, the distance image processing unit 4 controls the emission timing E to a timing advanced by 1 clock from the emission timing E in the first pattern. This is because the flare light is received with a delay of a period corresponding to 1 clock from the emission timing E in the first pattern shown in FIG. 5A. On the other hand, in the second pattern, the distance image processing unit 4 controls the gate opening and closing timings G1 to G4 to be the same timings as in the first pattern.

The distance image processing unit 4 drives the pixels 321 for one frame at the driving timing of such a second pattern, and acquires a storage signal corresponding to the charges stored in each of the pixels 321. The distance image processing unit 4 stores the storage signals SIG1 to SIG4 corresponding to the charge storage units CS1 to CS4 of the pixel 321, respectively.

Next, the distance image processing unit 4 performs the driving in the third pattern, as shown in the example of FIG. 5C. In the third pattern, the distance image processing unit 4 shortens the emission period for emitting the optical pulse PO by a period corresponding to 1 clock as compared with the second pattern. Accordingly, flare light shortened by a period corresponding to 1 clock is received, and target light shortened by a period corresponding to 1 clock is received.

On the other hand, in the third pattern, the distance image processing unit 4 controls the timing for starting the emission of the optical pulse PO and the gate opening and closing timings G1 to G4 to be the same timings as in the second pattern.

The distance image processing unit 4 drives the pixels 321 for one frame at the driving timing of such a third pattern, and acquires a storage signal corresponding to the charges stored in each of the pixels 321. The distance image processing unit 4 stores the storage signals SIG1 to SIG4 corresponding to the charge storage units CS1 to CS4 of the pixel 321, respectively.

Then, as shown in the example in FIG. 5D, the distance image processing unit 4 subtracts the storage signal corresponding to the driving in the third pattern from the storage signal corresponding to the driving in the second pattern in each of the pixels 321. Accordingly, a signal amount corresponding to the light amount of the flare light for the period corresponding to 1 clock is calculated from the storage signal SIG1 corresponding to the charges stored in the charge storage unit CS1 in the pixel 321.

Further, a signal amount corresponding to the light amount of the target light for a period corresponding to 1 clock is calculated from the storage signal SIG2 corresponding to the charges stored in the charge storage unit CS2 in the pixel 321.

The distance image processing unit 4 calculates a signal amount (flare signal amount) corresponding to the light amount of flare light received by the pixel 321 in the second pattern, based on the signal amount (1CLK flare signal amount) corresponding to the light amount of flare light for a period corresponding to 1 clock. For example, when the emission period of the optical pulse PO is a period corresponding to 4 clocks, the distance image processing unit 4 sets a value obtained by multiplying the 1CLK flare signal amount by four, as the flare signal amount.

The distance image processing unit 4 subtracts the flare signal amount from the storage signal SIG1 corresponding to the driving in the second pattern. Accordingly, the signal amount corresponding to the light amount of the flare light included in the storage signal SIG1 is subtracted. The distance image processing unit 4 calculates the distance by using the storage signal SIG1 after the subtraction. Accordingly, the distance image processing unit 4 can subtract a signal amount corresponding to the light amount of the flare light received by the pixel 321, from the storage signal of the pixel 321 that has received the flare light that should not be received. Therefore, the distance can be accurately calculated.

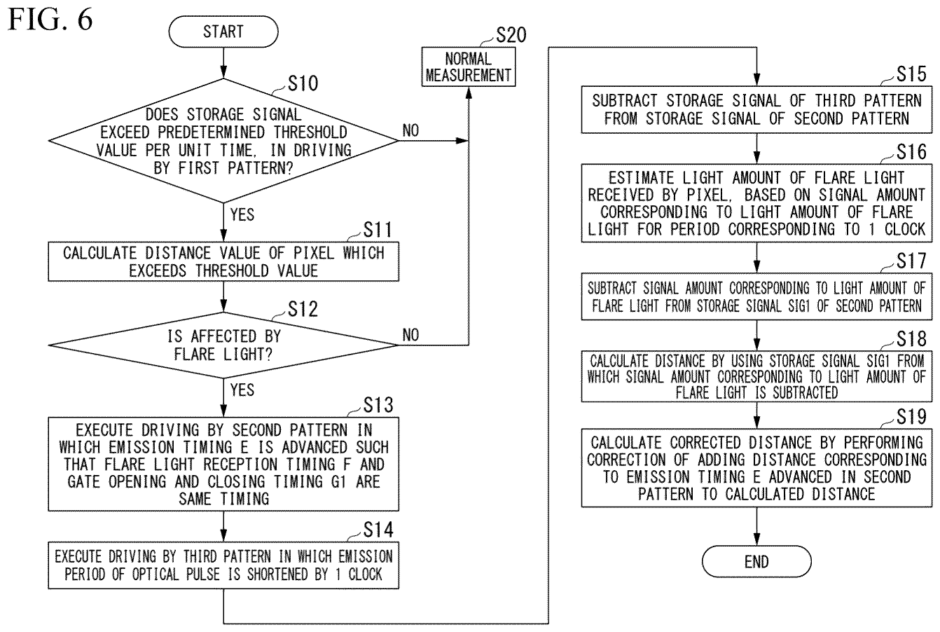

Here, a flow of process performed by the distance image capturing device 1 will be described with reference to FIG. 6. FIG. 6 is a flowchart showing a flow of the process performed by the distance image processing unit 4 according to the embodiment.

The distance image processing unit 4 drives the pixels 321 for one frame in the first pattern to acquire the storage signal corresponding to the amount of charges stored in each of the charge storage units CS1 to CS4. The distance image processing unit 4 determines whether or not the storage signal exceeds a predetermined threshold value per unit time (step S10). When the storage signal exceeds the predetermined threshold value, the distance image processing unit 4 calculates the distance based on the storage signal of the pixel (step S11). In a case where the determination is made that the pixel is affected by the flare light, from the representative value (a median value, a mean value, a variance, a standard deviation, a peak in histogram, or the like) based on the correspondence relationship between the calculated distance and the number of pixels, the distance image processing unit 4 performs the flare suppression process.

The distance image processing unit 4 executes the driving in the second pattern for one frame in which the emission timing E is advanced such that the flare light reception timing F and the gate opening and closing timing G1 are the same timing (step S13). The distance image processing unit 4 executes driving in a third pattern in which the emission period of the optical pulse PO is shortened by a period corresponding to 1 clock, for one frame (step S14). The distance image processing unit 4 subtracts the storage signal of the third pattern from the storage signal of the second pattern (step S15).

The distance image processing unit 4 estimates the signal amount of the light amount of the flare light received by the pixel 321, based on the signal amount corresponding to the light amount of the flare light for the period corresponding to 1 clock (step S16). For example, when the emission period of the optical pulse PO is a period corresponding to 4 clocks, the distance image processing unit 4 estimates a value obtained by multiplying the signal amount corresponding to the light amount of flare light for a period corresponding to 1 clock (1CLK flare signal amount) by four as a signal amount of the light amount of the flare light received by the pixel 321 (flare signal amount).

The distance image processing unit 4 subtracts the signal amount of the light amount of the flare light received by the pixel 321 (flare signal amount) from the storage signal SIG1 (storage signal corresponding to the amount of charges stored in the charge storage unit CS1) of the second pattern (step S17).

The distance image processing unit 4 calculates the distance by using the storage signal SIG1 after the subtraction and the storage signals SIG2 to SIG4 (step S18). In addition, the distance image processing unit 4 performs correction for adding a distance corresponding to the emission timing E advanced in the second pattern to the distance calculated in step S18, and sets the corrected distance as the distance to the object OB (step S19).

On the other hand, when there is no storage signal exceeding the threshold value in step S10 and when it is determined in step S12 that the pixel is not affected by the flare light, the distance image processing unit 4 executes normal distance measurement (step S20).

Here, the timing at which the target light is received changes in various ways depending on the position of the object OB. Even in a case where the timing at which the target light is received changes in various ways, it is possible to execute the flare suppression process of the present embodiment to calculate the flare signal amount.

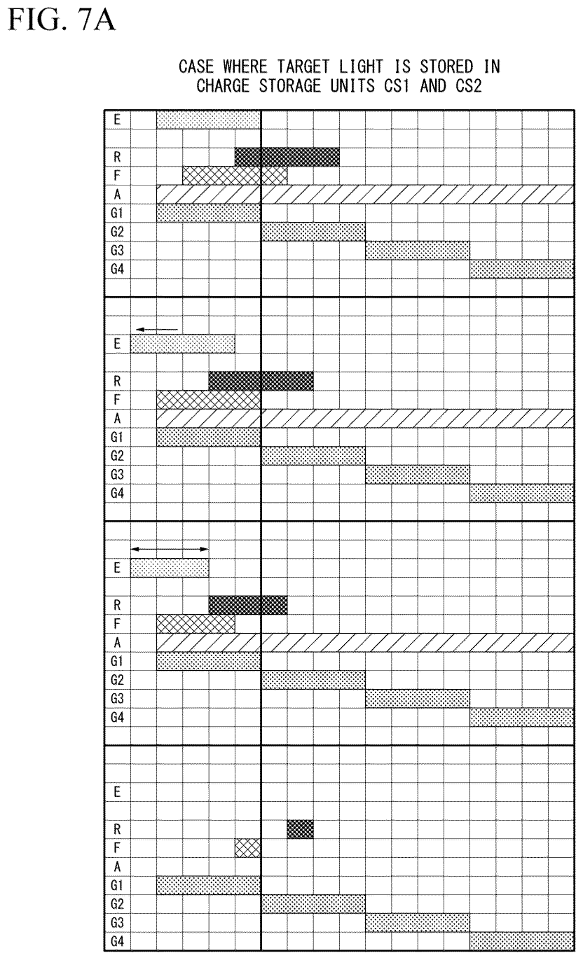

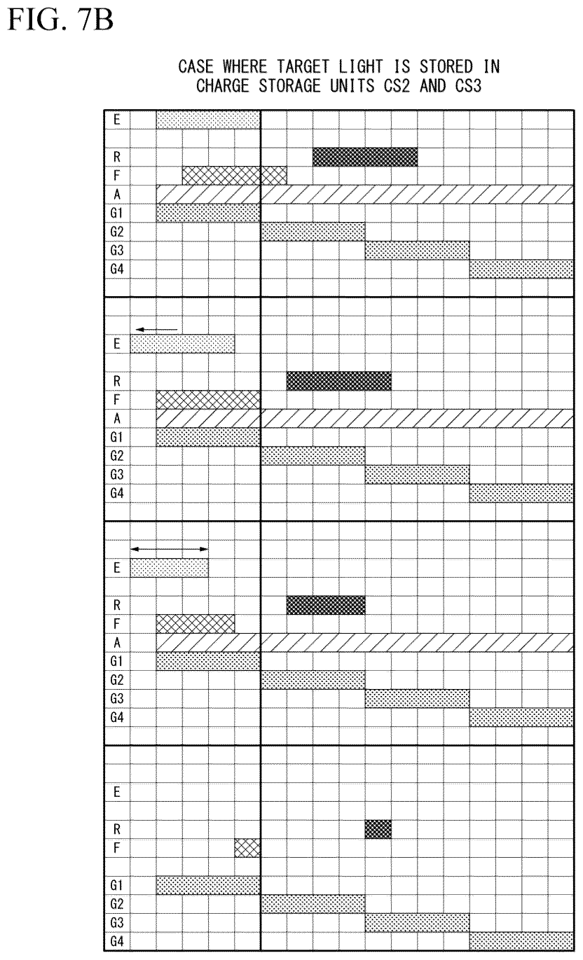

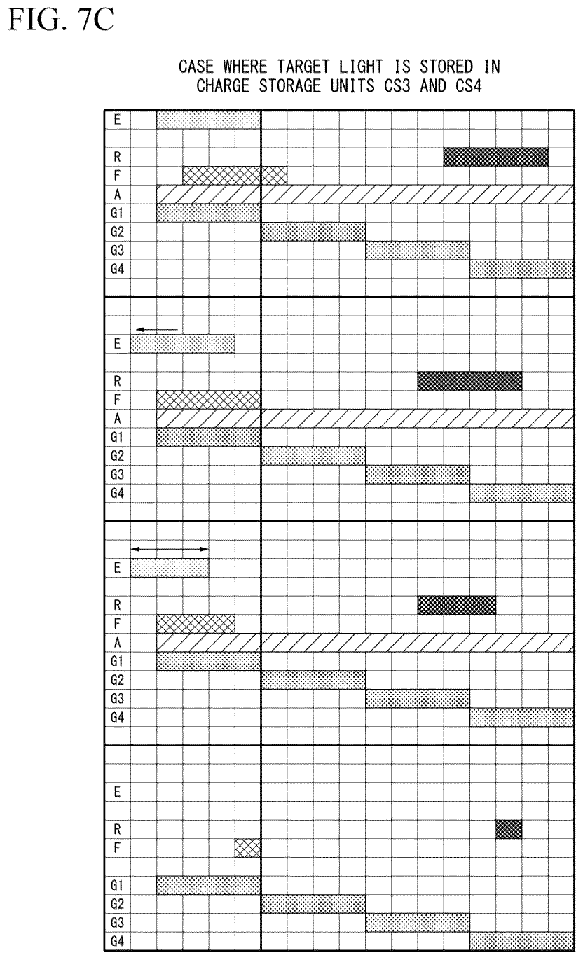

FIG. 7 (FIGS. 7A to 7C) are diagrams for describing the process performed by the distance image capturing device 1 according to the embodiment. FIG. 7 shows four timing charts. A top timing chart shows a driving timing in the first pattern, which corresponds to FIG. 5A. A second timing chart from the top shows a driving timing in the second pattern, which corresponds to FIG. 5B. A third timing chart from the top shows a driving timing in the third pattern, which corresponds to FIG. 5C. A bottom timing chart shows a subtraction value obtained by subtracting each storage signal in the third pattern from each storage signal in the second pattern, corresponding to FIG. 5D.

FIG. 7 shows an example in which target light is received at different timings. FIG. 7A shows an example of a case where the target light is stored in the charge storage units CS1 and CS2. The example in FIG. 7A is the same as in FIGS. 5, and as described above, it is possible to calculate the flare signal amount at the reflected light reception timing R such that the target light is stored in the charge storage units CS1 and CS2.

FIG. 7B shows an example of a case where the target light is stored in the charge storage units CS2 and CS3. Even at the reflected light reception timing R shown in FIG. 7B, by subtracting the storage signal corresponding to the driving in the third pattern from the storage signal corresponding to the driving in the second pattern, in the storage signal SIG1, the signal amount corresponding to the light amount of the flare light for the period corresponding to 1 clock is calculated. Therefore, it is possible to calculate the flare signal amount at the reflected light reception timing R such that the target light is stored in the charge storage units CS2 and CS3.

FIG. 7C shows an example of a case where the target light is stored in the charge storage units CS3 and CS4. Even at the reflected light reception timing R shown in FIG. 7C, by subtracting the storage signal corresponding to the driving in the third pattern from the storage signal corresponding to the driving in the second pattern, in the storage signal SIG1, the signal amount corresponding to the light amount of the flare light for the period corresponding to 1 clock is calculated. Therefore, it is possible to calculate the flare signal amount at the reflected light reception timing R such that the target light is stored in the charge storage units CS3 and CS4.

Further, various cases are assumed for the breakdown of the light received by the pixel 321. Specifically, there can be a case where the pixel 321 receives both the target light and the flare light in a mixed manner, a case where the pixel 321 receives only the flare light, and a case where the pixel 321 receives only the target light. Even in such various cases, it is possible to execute the flare suppression process of the present embodiment to calculate the flare signal amount.

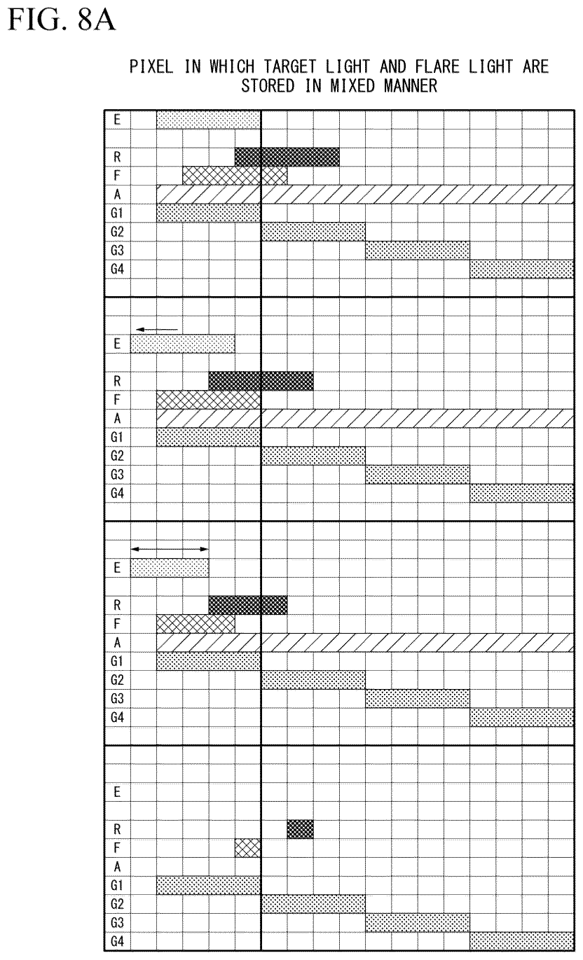

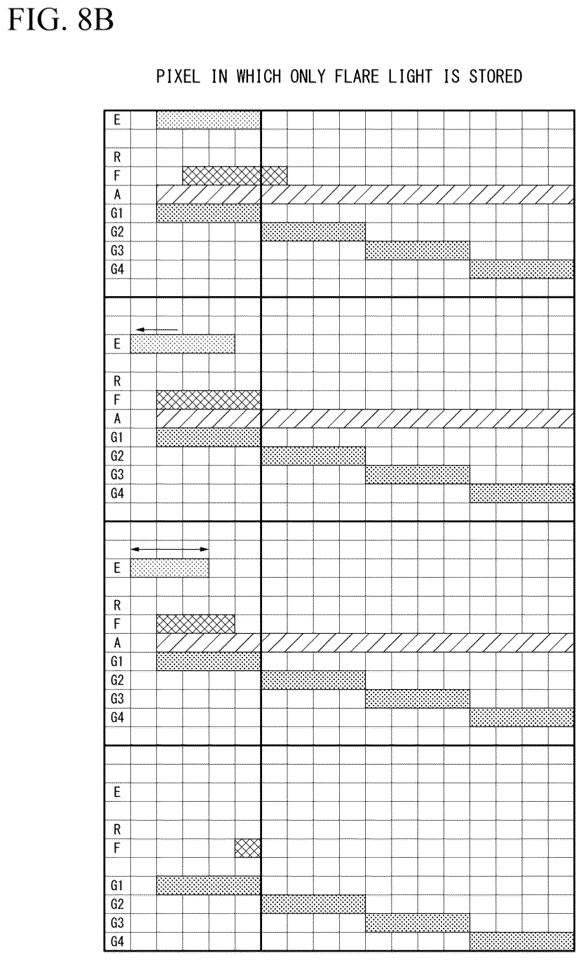

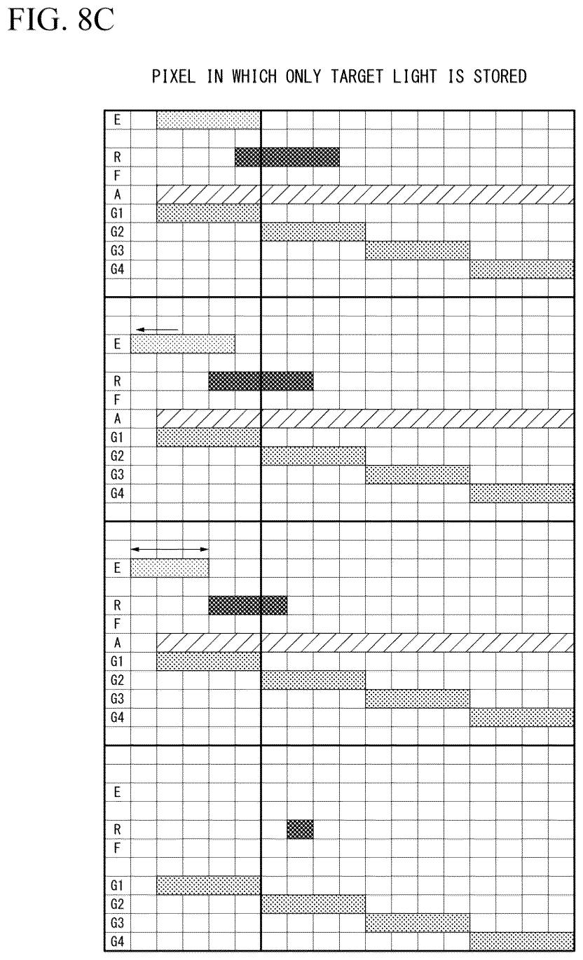

FIG. 8 (FIGS. 8A to 8C) are diagrams for describing the process performed by the distance image capturing device 1 according to the embodiment. FIG. 8 shows four timing charts as in FIG. 7. A top timing chart shows a driving timing in the first pattern, which corresponds to FIG. 5A. A second timing chart from the top shows a driving timing in the second pattern, which corresponds to FIG. 5B. A third timing chart from the top shows a driving timing in the third pattern, which corresponds to FIG. 5C. A bottom timing chart shows a subtraction value obtained by subtracting each storage signal in the third pattern from each storage signal in the second pattern, corresponding to FIG. 5D.

FIG. 8 shows an example of a case where light having different breakdowns is received. FIG. 8A shows an example of the case where the target light and the flare light are received in a mixed manner. The example in FIG. 8A is the same as in FIG. 5, and as described above, it is possible to calculate the flare signal amount in a case where the target light and the flare light are received in a mixed manner.

FIG. 8B shows an example of the case where only flare light is received. As shown in the example in FIG. 8B, even in a case where only flare light is received, by subtracting the storage signal corresponding to the driving in the third pattern from the storage signal corresponding to the driving in the second pattern, in the storage signal SIG1, the signal amount corresponding to the light amount of the flare light for the period corresponding to 1 clock is calculated. Therefore, it is possible to calculate the flare signal amount even in the case where only the flare light is received.

FIG. 8C shows an example of the case where only the target light is received. As shown in the example of FIG. 8C, even in a case where only the target light is received, by subtracting the storage signal corresponding to the driving in the third pattern from the storage signal corresponding to the driving in the second pattern, in the storage signal SIG1, the signal amount corresponding to the light amount (zero) of the flare light for the period corresponding to 1 clock is calculated. Therefore, it is possible to calculate the flare signal amount even in the case where only the target light is received.

As described above, in the distance image capturing device 1 according to the embodiment, the distance image processing unit 4 drives the pixel 321 by three driving patterns including the first pattern, the second pattern, and the third pattern. In the first pattern, the distance image processing unit 4 calculates the flare light reception timing F at which flare light is received, based on the distance calculated using the storage signal SIG corresponding to the amount of charges stored in each of the charge storage units CS of the pixel 321. In the second pattern, the distance image processing unit 4 controls the emission timing E such that the flare light reception timing F and the first gate opening and closing timing G1 for storing charges in the charge storage unit CS1 (first charge storage unit) in the pixel 321 are set to be the same timing. In the third pattern, the distance image processing unit 4 controls such that the emission period for emitting the optical pulse PO is shorter than the emission period in the second pattern. The distance image processing unit 4 calculates the flare signal amount corresponding to the light amount of the flare light received by the pixel 321, by using the subtraction value obtained by subtracting the storage signal SIG1 in the third pattern from the storage signal SIG1 in the second pattern. The distance image processing unit 4 calculates a distance to the object OB by using the calculated flare signal amount.

Accordingly, in the distance image capturing device 1 according to the embodiment, it is possible to calculate the flare signal amount corresponding to the light amount of the flare light received by the pixel 321. In addition, in the second pattern, charges corresponding to the light amount of all of the flare light can be stored in the specific charge storage unit (for example, the charge storage unit CS1). Accordingly, the flare signal amount can be subtracted from the storage signal. Therefore, it is possible to accurately calculate the distance by using a signal obtained by subtracting the flare signal amount from the storage signal. Moreover, it is possible to calculate the flare signal amount, by using the subtraction value obtained by subtracting the storage signal SIG1 in the third pattern from the storage signal SIG1 in the second pattern. Therefore, it is not necessary to generate four equations or to obtain parameters such that each equation becomes 0, and a calculation cost does not increase. That is, it is possible to subtract the amount of light received by the flare phenomenon without increasing the calculation cost.

Further, in the distance image capturing device 1 according to the embodiment, the distance image processing unit 4 uses a period (shortened period) corresponding to 1 clock, which is the difference between emission period in the third pattern and the emission period in the second pattern. The distance image processing unit 4 sets the subtraction value obtained by subtracting the storage signal SIG1 in the third pattern from the storage signal SIG1 in the second pattern, as 1CLK flare signal amount (partial flare signal amount) corresponding to the light amount of flare light in a period corresponding to 1 clock. The distance image processing unit 4 calculates a value obtained by multiplying a value obtained by dividing the 1CLK flare signal amount by the period corresponding to 1 clock (shortened period) by a period corresponding to 4 clocks (emission period in the second pattern), as the flare signal amount. Further, in the distance image capturing device 1 according to the embodiment, the shortened period is a period corresponding to 1 clock of the clock signal used to control the emission period. Further, the distance image processing unit 4 corrects the calculated distance using the signal amount obtained by subtracting the flare signal amount from the storage signal SIG1 (first storage signal corresponding to the amount of charges stored in the first charge storage unit in the second pattern) in the second pattern. The correction is of adding a distance corresponding to a period (a shortened period) corresponding to 1 clock to the calculated distance. The distance image processing unit 4 calculates the corrected distance as the distance to the object OB. Accordingly, in the distance image capturing device 1 according to the embodiment, it is possible to subtract the amount of light received by the flare phenomenon and accurately calculate the distance without increasing the calculation cost.

Here, the shortened period is a difference (subtracting value) between the emission period in the third pattern and the emission period in the second pattern, and the shortened period does not limit to a period corresponding to 1 clock. The shortened period may be set such that the subtraction value includes only a signal corresponding to the flare light that the pixel 321 received, does not include a signal corresponding to the reflected light RL.

The conditions for setting the shortened period can be determined as follows. Here, among the storage signal SIG1, a signal amount corresponding to the flare light refers to as a storage signal SIGIF and a signal amount corresponding to the reflected light RL refers to as a storage signal SIGIR. The conditions for setting the shortened period is a condition where the storage signal SIGIF in the second pattern is different from the storage signal SIGIF in the third pattern, and the storage signal SIGIR in the second pattern is equal to the storage signal SIGIR in the third pattern. This is, the shortened period is set to a period that an amount of charges corresponding to the flare light among the amount of charges stored in the charge storage unit CS1 in the second pattern is different from an amount of charges corresponding to the flare light among the amount of charges stored in the charge storage unit CS1 in the third pattern, and an amount of charges corresponding to the reflected light RL among the amount of charges stored in the charge storage unit CS1 in the second pattern is equal to an amount of charges corresponding to the reflected light RL among the amount of charges stored in the charge storage unit CS1 in the third pattern.

### Modification Example 1 of Embodiment

Here, Modification Example 1 of the embodiment will be described. The present modification example is different from the above-described embodiment in that a process corresponding to an actual measurement environment is performed.

In an actual measurement environment, it is rare for the difference between the timings of receiving the flare light and the target light to be an integral multiple of a period corresponding to 1 clock. Normally, the difference between the timings of receiving the flare light and the target light is not an integral multiple of 1 clock, and is likely to be halfway such as 1.3 clocks or 2.8 clocks.

For example, it is assumed that an object that can be a flare generation source (for example, a flare generation source object OB2) is present at a distance of 50 [cm] from the distance image capturing device 1, and an object to be measured (for example, the target object OB1 in FIG. 4A) is present at a distance of 1 [m] from the distance image capturing device 1. Further, it is assumed that the clock frequency is 432 [MHz] and the emission period is a period corresponding to 4 clocks.

In such a measurement environment, regarding the reflected light RL (flare light) reflected by and received by an object that can be a flare generation source, the distance over which the optical pulse PO reciprocates is 1 [m] (=50 [cm]×2), and thus the time required for reciprocating is 3.3 [ns] (=1 [m]/3E8). Therefore, the timing (flare light reception timing F) at which light coming from an object that can be a flare generation source is received by the pixel 321 is a timing delayed for a period corresponding to 1.4 clocks (=3.3 [ns]/2.3 [ns]) from the emission timing E.

On the other hand, regarding the reflected light RL (target light) that is reflected by and received by the object to be measured, the distance over which the optical pulse PO reciprocates is 2 [m] (=1 [m]×2), and thus the time required for reciprocating is 6.6 [ns] (=2 [m]/3E8). Therefore, the timing (flare light reception timing F) at which light coming from an object that can be a flare generation source is received by the pixel 321 is a timing delayed for a period corresponding to 2.8 clocks (=6.6 [ns]/2.3 [ns]) from the emission timing E.

In this case, the difference between the timings of receiving the flare light and the target light becomes a period corresponding to 1.4 clocks, and does not become an integral multiple of the period corresponding to 1 clock.

In the present modification example, a process (referred to as a half-end clock correspondence process) corresponding to a case where the difference between the timings of receiving the flare light and the target light is not an integral multiple of the period corresponding to 1 clock is executed.

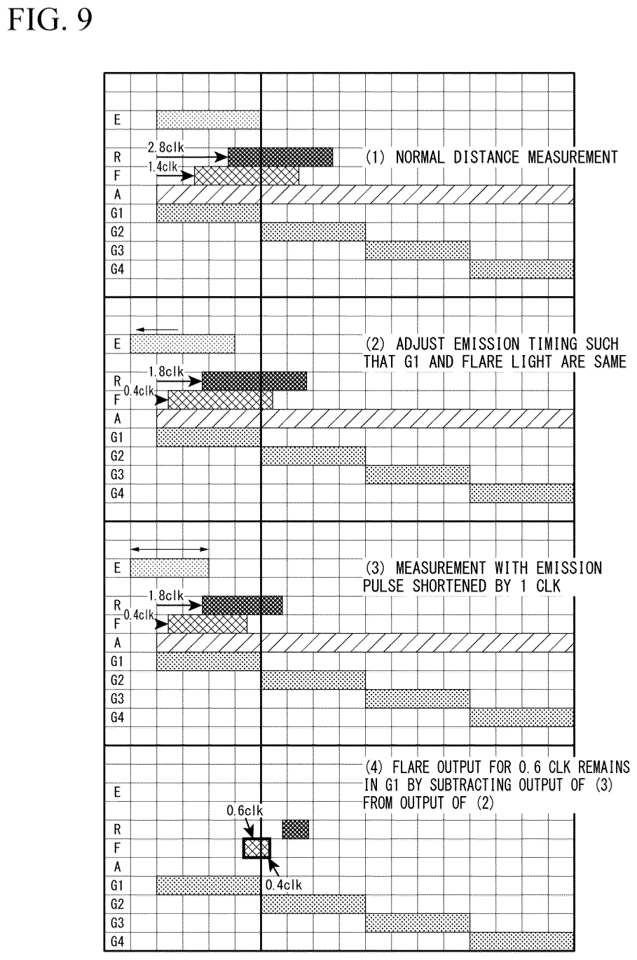

The half-end clock correspondence process will be described with reference to FIG. 9. FIG. 9 is a diagram for describing the process performed by the distance image capturing device 1 according to Modification Example 1 of the embodiment.

FIG. 9 shows four timing charts as in FIGS. 7 and 8. A top timing chart shows a driving timing in the first pattern, which corresponds to FIG. 5A. A second timing chart from the top shows a driving timing in the second pattern, which corresponds to FIG. 5B. A third timing chart from the top shows a driving timing in the third pattern, which corresponds to FIG. 5C. A bottom timing chart shows a subtraction value obtained by subtracting each storage signal in the third pattern from each storage signal in the second pattern, corresponding to FIG. 5D.

FIG. 9 shows an example in which the difference between the timings of receiving the flare light and the target light does not become an integral multiple of the period corresponding to 1 clock. In the example of FIG. 9, in the driving in the first pattern, the reflected light reception timing R arrives after a period corresponding to 2.8 clocks from the emission timing E, and the target light is received. In addition, the flare light reception timing F arrives after a period corresponding to 1.4 clock from the emission timing E, and the flare light is received.

In this case, in driving in the second pattern, the distance image processing unit 4 advances the emission timing E by 1 clock unit such that the difference between the flare light reception timing F and the gate opening and closing timing G1 is less than a period corresponding to 1 clock.

In an example in FIG. 9, in driving in the second pattern, after the distance image processing unit 4 advances the emission timing E by 1 clock and controls the gate opening and closing timing G1 to be in the ON state, the distance image processing unit 4 causes the flare light to be received with a delay of a period corresponding to 0.4 clocks.

Further, in the driving in the third pattern, the distance image processing unit 4 shortens the emission period by a period corresponding to 1 clock as compared with the second pattern, as in the above-described embodiment.

Accordingly, in the present modification example, the distance image processing unit 4 calculates a signal amount corresponding to a light amount of flare light for a period corresponding to 0.6 clocks, from the storage signal SIG1 after the subtraction obtained by subtracting a storage signal corresponding to the driving in the third pattern from the storage signal corresponding to the driving in the second pattern.

The distance image processing unit 4 calculates a signal amount (flare signal amount) corresponding to the light amount of flare light received by the pixel 321 in the second pattern, based on the signal amount (0.6CLK flare signal amount) corresponding to the light amount of flare light for a period corresponding to 0.6 clock. For example, when the emission period of the optical pulse PO is a period corresponding to 4 clocks, the distance image processing unit 4 sets a value obtained by multiplying a value, obtained by dividing the 0.6CLK flare signal amount by 0.6, by four, as the flare signal amount.

As described above, in the distance image capturing device 1 according to Modification Example 1 of the embodiment, in a case where in the first pattern, the difference between the flare light reception timing F and the gate opening and closing timing G1 is not an integral multiple of the period corresponding to one clock, the distance image processing unit 4 controls the emission timing E in the second pattern such that the difference between the flare light reception timing F and the gate opening and closing timing G1 is less than a period corresponding to 1 clock. The distance image processing unit 4 calculates the flare signal amount corresponding to the light amount of the flare light received by the pixel 321, by using the subtraction value obtained by subtracting the storage signal SIG1 in the third pattern from the storage signal SIG1 in the second pattern. The distance image processing unit 4 sets the subtraction value obtained by subtracting the storage signal SIG1 in the third pattern from the storage signal SIG1 in the second pattern, as 0.6CLK flare signal amount (partial flare signal amount) corresponding to the light amount of flare light in a period less than a period corresponding to 1 clock. The distance image processing unit 4 calculates a value obtained by multiplying a value, obtained by dividing the 0.6CLK flare signal amount by the period (shortened period) corresponding to a period less than 1 clock, by a period (emission period in the second pattern) corresponding to 4 clocks, as the flare signal amount.

Accordingly, in the distance image capturing device 1 according to Modification Example 1 of the embodiment, even in a case where the difference between the timings of receiving the flare light and the target light is not an integral multiple of the period corresponding to 1 clock, the flare signal amount can be calculated.

### Modification Example 2 of Embodiment

Here, Modification Example 2 of the embodiment will be described. The present modification example is different from the above-described embodiment in that a process corresponding to an actual measurement environment is performed.

In an actual measurement environment, the control pulse is not rectangular, and waveform rounding often occurs. In the present modification example, a process corresponding to a case where the control is performed by using such a control pulse having a rounded waveform (referred to as waveform rounding correspondence process) is executed.

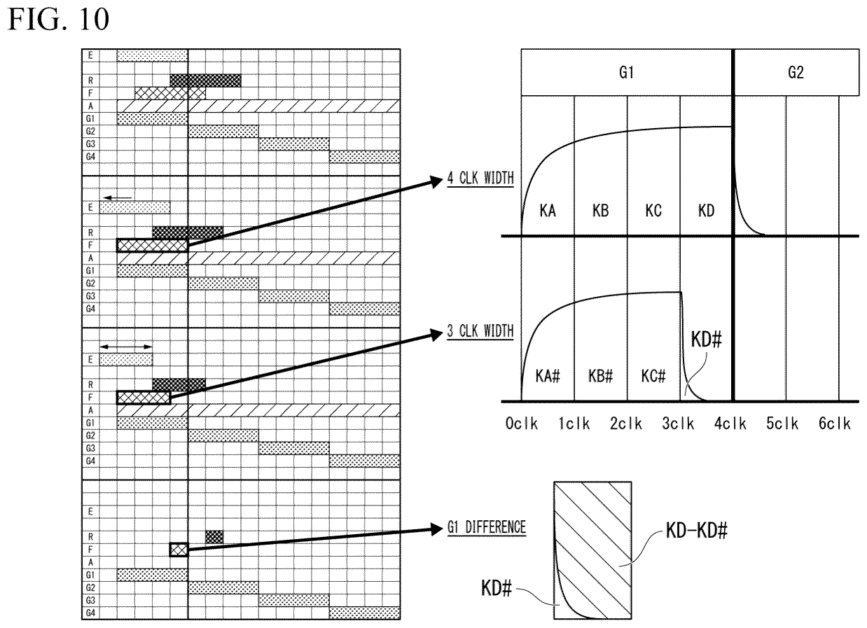

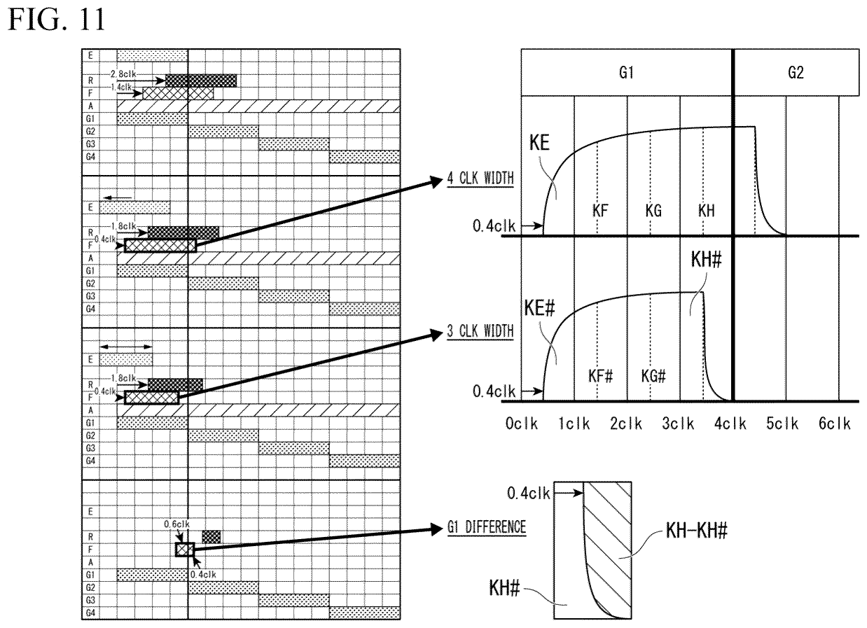

The waveform rounding correspondence processing will be described with reference to FIG. 10. FIG. 10 is a diagram for describing the process performed by the distance image capturing device 1 according to Modification Example 2 of the embodiment.

The left side of FIG. 10 shows four timing charts as in FIGS. 7 and 8. A top timing chart shows a driving timing in the first pattern, which corresponds to FIG. 5A. A second timing chart from the top shows a driving timing in the second pattern, which corresponds to FIG. 5B. A third timing chart from the top shows a driving timing in the third pattern, which corresponds to FIG. 5C. A bottom timing chart shows a subtraction value obtained by subtracting each storage signal in the third pattern from each storage signal in the second pattern, corresponding to FIG. 5D.

The right side of FIG. 10 schematically shows the transition of the light amount of the flare light in a case where the control pulse has waveform rounding. The control pulse here is, for example, a control pulse used for controlling the emission timing for emitting the optical pulse PO.

In the upper stage on the right side of FIG. 10, a transition in the light amount of flare light corresponding to 4 clocks (4 clk width) in the second pattern is shown. The light amount of the flare light in the second pattern is a light amount KA in the period corresponding to 0 (zero) [clk] to 1 [clk], is a light amount KB in the period corresponding to 1 [clk] to 2 [clk], is a light amount KC in the period corresponding to 2 [clk] to 3 [clk], and is a light amount KD in the period corresponding to 3 [clk] to 4 [clk].

In the middle stage on the right side of FIG. 10, a transition in the light amount of flare light corresponding to 3 clocks (3clk width) in the third pattern is shown. The light amount of the flare light in the third pattern is a light amount KA #in the period corresponding to 0 (zero) [clk] to 1 [clk], is a light amount KB #for the period corresponding to 1 [clk] to 2 [clk], is a light amount KC #in the period corresponding to 2 [clk] to 3 [clk], and is a light amount KD #in the period corresponding to 3 [clk] to 4 [clk].

In the lower stage on the right side of FIG. 10, the light amount of flare light for a period corresponding to 1 clock calculated by subtracting the light amount of flare light corresponding to the driving in the third pattern from the light amount of flare light corresponding to the driving in the second pattern is schematically shown. Here, in a case where there is waveform rounding, since it can be said that the rising characteristics of the control pulse are the same in the second pattern and the third pattern, it is possible to consider that light amount KA=light amount KA #, light amount KB=light amount KB #, and light amount KC=light amount KC #. Therefore, in a case where there is waveform rounding, the light amount of the flare light for the period corresponding to 1 clock is the light amount (KD−KD #).

From such a viewpoint, in the present modification example, the distance image processing unit 4 calculates a signal amount corresponding to the light amount (KD-KD #) of flare light for a period corresponding to 1 clock in the case where there is waveform rounding, from the storage signal SIG1 after the subtraction obtained by subtracting a storage signal corresponding to the driving in the third pattern from the storage signal corresponding to the driving in the second pattern.

For example, by measuring the waveform characteristics of the control pulse in advance, the ratio of the light amount (KD−KD #) of flare light for a period corresponding to 1 clock in the case where there is waveform rounding to the light amount (KA+KB+KC+KD) of flare light for a period corresponding to 4 clocks, which is the emission period in the case where there is waveform rounding is obtained and stored. Accordingly, the distance image processing unit 4 calculates a signal amount corresponding to the light amount (KD−KD #), and can calculate, from the calculated signal amount, the flare signal amount corresponding to the light amount (KA+KB+KC+KD) of flare light received by the pixel 321.

As described above, in the distance image capturing device 1 according to Modification Example 2 of the embodiment, in a case where the control pulse for controlling the emission of the optical pulse PO has waveform rounding, the distance image processing unit 4 calculates the flare signal amount corresponding to the light amount of the flare light received by the pixel 321, by using a subtraction value obtained by subtracting the storage signal SIG1 in the third pattern from the storage signal SIG1 in the second pattern and the waveform characteristic of the control pulse. Accordingly, in the distance image capturing device 1 according to Modification Example 1 of the embodiment, even in a case where the control pulse for controlling the emission of the optical pulse PO has waveform rounding, it is possible to calculate the flare signal amount.

### Modification Example 3 of Embodiment

Here, Modification Example 3 of the embodiment will be described. The present modification example is different from the above-described embodiment in that a process corresponding to an actual measurement environment is performed.

In the present modification example, a process (referred to as half-end clock waveform rounding correspondence process) corresponding to a case where Modification Example 1 and Modification Example 2 described above are combined, that is, a case where the difference between the timings of receiving the flare light and the target light is not an integral multiple of 1 clock and the control pulse is not rectangular is executed.

The half-end clock waveform rounding correspondence process will be described with reference to FIG. 11. FIG. 11 is a diagram for describing the process performed by the distance image capturing device 1 according to Modification Example 3 of the embodiment.

The left side of FIG. 11 shows four timing charts as in FIGS. 7 and 8. A top timing chart shows a driving timing in the first pattern, which corresponds to FIG. 5A. A second timing chart from the top shows a driving timing in the second pattern, which corresponds to FIG. 5B. A third timing chart from the top shows a driving timing in the third pattern, which corresponds to FIG. 5C. A bottom timing chart shows a subtraction value obtained by subtracting each storage signal in the third pattern from each storage signal in the second pattern, corresponding to FIG. 5D.

On the left side of FIG. 11, in the driving in the first pattern, the reflected light reception timing R arrives after a period corresponding to 2.8 clocks from the emission timing E, and the target light is received. In addition, the flare light reception timing F arrives after a period corresponding to 1.4 clock from the emission timing E, and the flare light is received.

In driving in the second pattern, after the distance image processing unit 4 advances the emission timing E by 1 clock and controls the gate opening and closing timing G1 to be in the ON state, the distance image processing unit 4 causes the flare light to be received with a delay of a period corresponding to 0.4 clocks.

On the right side of FIG. 11, the transition of light amount of the flare light in a case where the difference between the timings of receiving the flare light and the target light is not an integral multiple of 1 clock and the control pulse has waveform rounding is schematically shown.

The upper right part of FIG. 11 shows a transition in the light amount of flare light corresponding to four clocks (4 clk width) in the second pattern. In the driving in the second pattern, the flare light is received with a delay of a period corresponding to 0.4 clocks, after the gate opening and closing timing G1 is controlled to be in the ON state. The light amount of the flare light in the second pattern is a light amount KE in the period corresponding to 0 (zero) [clk] to 1 [clk], is a light amount KF in the period corresponding to 1 [clk] to 2 [clk], is a light amount KG in the period corresponding to 2 [clk] to 3 [clk], and is a light amount KH in the period corresponding to 3 [clk] to 4 [clk].

In the middle stage on the right side of FIG. 11, a transition in the light amount of the flare light corresponding to 3 clocks (3clk width) in the third pattern is shown. In the driving in the third pattern, the flare light is received with a delay of a period corresponding to 0.4 clocks, after the gate opening and closing timing G1 is controlled to be in the ON state. The light amount of the flare light in the third pattern is a light amount KE #in the period corresponding to 0 (zero) [clk] to 1 [clk], is a light amount KF #in the period corresponding to 1 [clk] to 2 [clk], is a light amount KG #in the period corresponding to 2 [clk] to 3 [clk], and is a light amount KH #in the period corresponding to 3 [clk] to 4 [clk].

In the lower stage on the right side of FIG. 11, the light amount of flare light for a period corresponding to 0.6 clock calculated by subtracting the light amount of flare light corresponding to the driving in the third pattern from the light amount of flare light corresponding to the driving in the second pattern is schematically shown. Here, in the case where there is waveform rounding, it can be said that the rising characteristics of the control pulse are the same in the second pattern and the third pattern. Further, in both the second pattern and the third pattern, the flare light is received with a delay of a period corresponding to 0.4 clocks, after the gate opening and closing timing G1 is controlled to be in the ON state. From these, it is possible to regard that the light amount KE=the light amount KE #, the light amount KF=the light amount KF #, and the light amount KG=the light amount KG #. Therefore, in the case where there is waveform rounding, the light amount of flare light for the period corresponding to 0.6 clocks is the light amount (KH−KH #).

From such a viewpoint, in the present modification example, the distance image processing unit 4 calculates a signal amount corresponding to the light amount (KH−KH #) of flare light for a period corresponding to 0.6 clocks in the case of having the waveform rounding, from the storage signal SIG1 after the subtraction obtained by subtracting a storage signal corresponding to the driving in the third pattern from the storage signal corresponding to the driving in the second pattern.

For example, the light amount (KE+KF+KG+KH) of flare light for a period corresponding to 4 clocks which is the emission period of the optical pulse PO is obtained from the light amount of flare light (KH−KH #) for a period corresponding to 0.6 clocks, by using a look-up table (LUT) stored in advance.

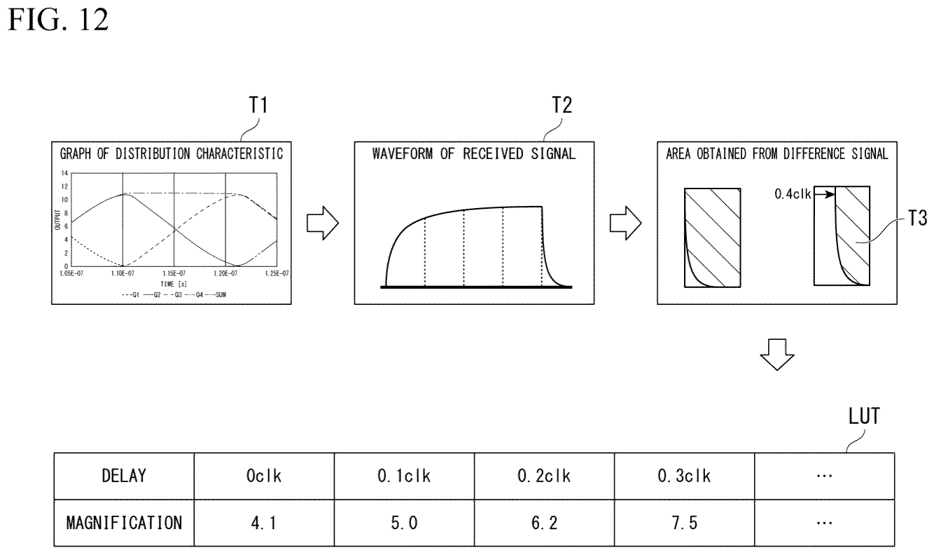

Here, LUT will be described with reference to FIG. 12. FIG. 12 is a diagram showing an example of LUT according to Modification Example 3 of the embodiment. The LUT is, for example, a table in which the delay amount and the magnification are associated with each other. The delay amount is a period from the timing at which the gate opening and closing timing G1 is controlled to be in the ON state, to the arrival of flare light. The magnification is a multiplication value by which the light amount of the flare light corresponding to the delay amount is multiplied to obtain the light amount of the flare light for a period corresponding to 4 clocks that are the emission period of the optical pulse PO. In the example in FIG. 12, it is shown that a magnification is 4.1 times for a delay amount (delay) of 0 clk, a magnification is 5.0 times for a delay amount (delay) of 0.1 clk, and the like.

For example, it is possible to obtain the light receiving characteristic T2 of the flare light by acquiring the distribution characteristic T1 of the charge transfer transistor G and differentiating the acquired distribution characteristic with time. The light receiving characteristic T2 is, for example, a change over time in the flare light received by the distance image capturing device 1.

The distance image processing unit 4 calculates the number of clocks (here, 1.4 clocks) corresponding to a difference between the emission timing E and the flare light reception timing F, based on the storage signal based on the driving in the first pattern. In addition, the distance image processing unit 4 advances the flare light reception timing F by 1 clock such that the difference between the gate opening and closing timing G1 and the flare light reception timing F is less than the period corresponding to 1 clock in the second pattern, and controls the flare light reception timing F to arrive with a delay of a period corresponding to 0.4 clocks from the gate opening and closing timing G1. In this case, the delay amount is 0.4 clocks.

For example, the distance image processing unit 4 calculates the number of clocks (for example, 1.4 clocks) corresponding to a difference between the emission timing E and the flare light reception timing F, based on the storage signal based on the driving in the first pattern. Further, the distance image processing unit 4 calculates a signal amount corresponding to a light amount T3 of flare light for a period corresponding to 0.6 clocks, stored in the charge storage unit CS1 with a delay amount of 0.4 clocks, from the storage signal SIG1 after subtracting a storage signal corresponding to the driving in the third pattern from the storage signal corresponding to the driving in the second pattern.

The distance image processing unit 4 acquires the magnification corresponding to the delay amount of 0.4 clocks, based on the light amount T3 corresponding to the delay amount of 0.4 clocks, with reference to LUT. The distance image processing unit 4 sets a multiplication value obtained by multiplying the light amount T3 corresponding to the delay amount of 0.4 clocks by a magnification corresponding to the delay amount of 0.4 clocks as the light amount of the flare light for the period corresponding to 4 clocks that is the emission period of the optical pulse PO.

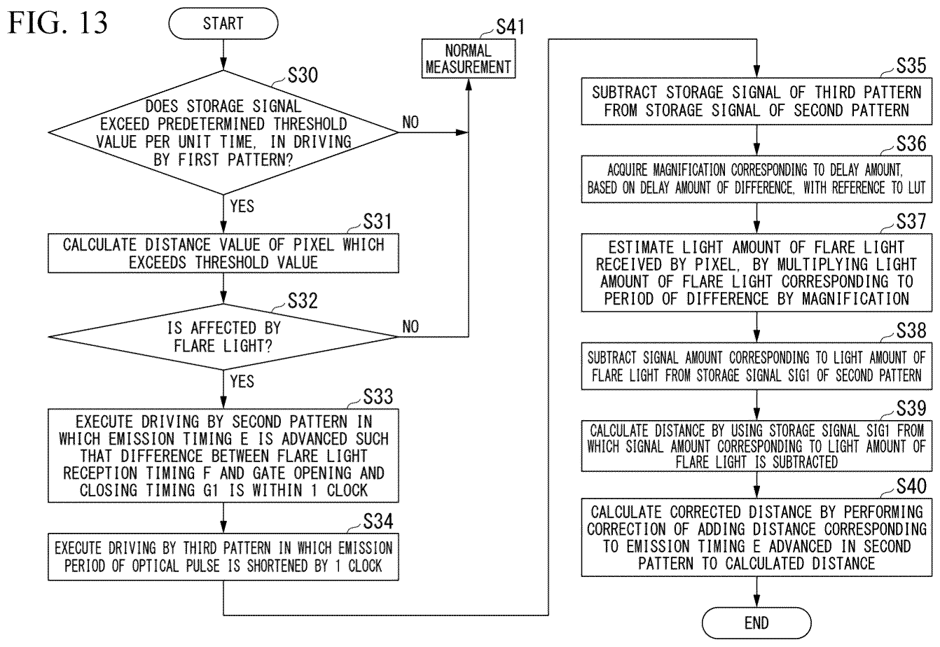

Here, a flow of process performed by the distance image capturing device 1 in the modification example will be described with reference to FIG. 13. FIG. 13 is a flowchart showing a flow of the process performed by the distance image processing unit 4 according to Modification Example 3 of the embodiment. This flow can also be applied to Modification Example 1 and Modification Example 2.

In this flow, it is assumed that a LUT indicating the correspondence relationship between the delay amount and the magnification is stored in advance, as shown in FIG. 12.

In addition, since the processes shown in steps S30 to S32, S34 to S35, and S38 to S41 in this flow are the same as the processes shown in steps S10 to S12, S14 to S15, and S17 to S20 in FIG. 6, the description thereof will be omitted.

In step S33, the distance image processing unit 4 executes the driving in the second pattern for one frame in which the emission timing E is advanced such that the difference between the flare light reception timing F and the gate opening and closing timing G1 is less than a period corresponding to 1 clock.

In step S36, the distance image processing unit 4 acquires the magnification corresponding to the delay amount, based on the delay amount corresponding to the difference between the flare light reception timing F and the gate opening and closing timing G1, with reference to LUT.

In step S37, the distance image processing unit 4 estimates the light amount of the flare light received by the pixel by multiplying the light amount of the flare light corresponding to the delay amount of the difference by the magnification acquired in step S36.

As described above, in the distance image capturing device 1 according to Modification Example 3 of the embodiment, in a case where in the first pattern, the difference between the flare light reception timing F and the gate opening and closing timing G1 is not an integral multiple of the period corresponding to one clock, and the control pulse that controls the emission of the optical pulse PO has waveform rounding, the distance image processing unit 4 controls the emission timing E in the second pattern such that the difference between the flare light reception timing F and the gate opening and closing timing G1 is less than a period corresponding to 1 clock. The distance image processing unit 4 calculates the flare signal amount corresponding to the light amount of the flare light received by the pixel 321, by using the subtraction value obtained by subtracting the storage signal SIG1 in the third pattern from the storage signal SIG1 in the second pattern, and the waveform characteristic of the control pulse that controls the emission of the optical pulse PO. Accordingly, in the distance image capturing device 1 according to Modification Example 3 of the embodiment, even in a case where the difference between the flare light reception timing F and the gate opening and closing timing G1 is not an integral multiple of the period corresponding to 1 clock, and the control pulse for controlling the emission of the optical pulse PO has waveform rounding, it is possible to calculate the flare signal amount.

### Modification Example 4 of Embodiment

Here, Modification Example 4 of the embodiment will be described. The present modification example is different from the above-described embodiment in that the previous driving result is used in a part of the three driving patterns (first pattern, second pattern, and third pattern).

In the above-described embodiment, it took time to measure because a measurement result cannot be obtained unless driving for three frames corresponding to driving of the three driving patterns is executed.

On the other hand, in the present modification example, the previous driving result is used in a part of the three driving patterns. By using the previous driving result, it is possible to reduce the processing load and to output the measurement result quickly.

For example, in the present modification example, an aspect is considered in which the previous driving results are used for two driving results among the three driving patterns.

Specifically, the distance image processing unit 4 drives three driving patterns (first pattern, second pattern, and third pattern) in the first measurement, and outputs the first measurement result, based on the driving results.

Next, the distance image processing unit 4 drives one driving pattern (first pattern) in the second measurement, and outputs the second measurement result, based on the first driving results of the second pattern and third pattern and the second driving result of the first pattern.

Next, the distance image processing unit 4 drives one driving pattern (second pattern) in the third measurement, and outputs the third measurement result, based on the first driving result of the third pattern, the second driving result of the first pattern, and the third driving result of the second pattern.

Similarly, even in the subsequent drivings, the current measurement is performed based on the driving result of one driving pattern driven this time and the driving results of the two driving patterns previously driven.

Alternatively, in the present modification example, an aspect is considered in which the previous driving result is used for one driving result among the three driving patterns.

Specifically, the distance image processing unit 4 drives three driving patterns (first pattern, second pattern, and third pattern) in the first measurement, and outputs the first measurement result, based on the driving results.

Next, the distance image processing unit 4 drives two driving patterns (first pattern and second pattern) in the second measurement, and outputs the second measurement result, based on the first driving result of the third pattern and the second driving result of the first pattern and the second pattern.

Next, the distance image processing unit 4 drives two driving patterns (third pattern and first pattern) in the third measurement, and outputs the third measurement result, based on the second driving results of the second pattern and the third driving result of the third pattern and the first pattern.

Similarly, even in the subsequent drivings, the current measurement is performed based on the driving result of two driving patterns driven this time and the driving results of the two driving patterns previously driven.

As described above, in the distance image capturing device 1 according to Modification Example 4 of the embodiment, the distance image processing unit 4 drives the pixel 321 in a part of the plurality of driving patterns in the second and subsequent measurements, and calculates the distance to the object OB by using the current driving result and the previous driving results. Accordingly, in the distance image capturing device 1 according to Modification Example 4 of the embodiment, it is possible to reduce the processing load and to quickly output the measurement result.

All or a part of the distance image capturing device 1 and the distance image processing unit 4 in the above-described embodiment may be implemented by a computer. In that case, a program for implementing this function may be recorded on a computer-readable recording medium, and the program recorded on the recording medium may be read and executed by a computer system to implement the reporting device. The term “computer system” as used herein includes an OS and hardware such as peripheral devices. Further, the “computer-readable recording medium” refers to a portable medium such as a flexible disk, a magneto-optical disk, a ROM, or a CD-ROM, or a storage device such as a hard disk built in a computer system. Further, a “computer-readable recording medium” may include those which dynamically hold programs for a short period of time, such as a communication line when a program is transmitted via a network such as the Internet or a communication line such as a telephone line, or those which hold programs for a certain period of time, such as a volatile memory inside a computer system that serves as a server or client in that case. Further, the above program may be for implementing a part of the above-described functions, may be for implementing the above-described functions in combination with a program already recorded in the computer system, or may be implemented by using a programmable logic device such as FPGA.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

### EXPLANATION OF REFERENCES

1: distance image capturing device
2: light source unit
3: Light receiving unit
321: pixel
4: distance image processing unit
CS: charge storage unit
G1, G2, G3, G4: charge transfer transistor
GD1, GD2: Charge discharge transistor
PD: photoelectric conversion element
PO: optical pulse

What is claimed is:

1. A distance image capturing device comprising:
a light source unit that irradiates an optical pulse to a space to be measured;
a light receiving unit having:
a pixel including a photoelectric conversion element that generates charges according to light incident from the space to be measured and a plurality of charge storage units that store the charges; and
a pixel drive circuit that performs driving of storing the charges in each of the charge storage units; and
a distance image processing unit
that controls the pixel drive circuit such that the charges are distributed to the charge storage units and stored in each of the charge storage units at a storage timing synchronized with an emission timing of emitting the optical pulse, and
that calculates a distance to an object based on an amount of charges stored in each of the charge storage units,
wherein the distance image processing unit
drives the pixel with three driving patterns including a first pattern, a second pattern, and a third pattern,
calculates a flare light reception timing at which flare light is received, based on a storage signal corresponding to the amount of charges stored in each of the charge storage units of the pixel, in the first pattern,
controls the emission timing such that the flare light reception timing and an opening and closing timing of a first gate for storing the charges in a first charge storage unit among the charge storage units in the pixel are the same timing, in the second pattern,
controls such that an emission period of emitting the optical pulse is shorter than an emission period in the second pattern, in the third pattern, and
calculates a flare signal amount corresponding to a light amount of the flare light received by the pixel, by using a subtraction value obtained by subtracting the storage signal in the third pattern from the storage signal in the second pattern, to calculate the distance to the object by using the calculated flare signal amount.

2. The distance image capturing device according to claim 1, wherein
by using a shortened period that is a difference between the emission period in the third pattern and the emission period in the second pattern,
the distance image processing unit
sets the subtraction value as a partial flare signal amount corresponding to a light amount of the flare light in the shortened period, and
calculates a value obtained by multiplying a value, obtained by dividing the partial flare signal amount by the shortened period, by the emission period in the second pattern, as the flare signal amount.

3. The distance image capturing device according to claim 2, wherein
the shortened period is set to a period that
an amount of charges corresponding to the flare light among the amount of charges stored in the first charge storage unit in the second pattern is different from an amount of charges corresponding to the flare light among the amount of charges stored in the first charge storage unit in the third pattern, and
an amount of charges corresponding to a reflected light that the optical pulse is reflected by an object among the amount of charges stored in the first charge storage unit in the second pattern is equal to an amount of charges corresponding to the reflected light among the amount of charges stored in the first charge storage unit in the third pattern.

4. The distance image capturing device according to claim 2, wherein
the shortened period is a period corresponding to 1 clock of a clock signal used to control the emission period.

5. The distance image capturing device according to claim 2, wherein
the distance image processing unit
performs correction of adding a distance corresponding to the shortened period to a distance calculated by using a signal amount obtained by subtracting the flare signal amount from a first storage signal corresponding to an amount of the charges stored in the first charge storage unit in the second pattern, and
calculates the corrected distance as the distance to the object.

6. The distance image capturing device according to claim 1, wherein
in a case where in the first pattern, a difference between the flare light reception timing and the first gate opening and closing timing is not an integral multiple of a period corresponding to 1 clock of a clock signal used to control the emission period,
the distance image processing unit
controls the emission timing in the second pattern such that the difference between the flare light reception timing and the first gate opening and closing timing is less than a period corresponding to 1 clock of the clock signal, and
calculates the flare signal amount, by using a subtraction value obtained by subtracting the storage signal in the third pattern from the storage signal in the second pattern and the difference.

7. The distance image capturing device according to claim 1, wherein
in a case where a control pulse for controlling the emission of the optical pulse has waveform rounding,
the distance image processing unit calculates the flare signal amount, by using a subtraction value obtained by subtracting the storage signal in the third pattern from the storage signal in the second pattern, and a waveform characteristic of the control pulse.

8. The distance image capturing device according to claim 1, wherein
in a case where in the first pattern, a difference between the flare light reception timing and the first gate opening and closing timing is not an integral multiple of a period corresponding to 1 clock of a clock signal used to control the emission period, and a control pulse that controls emission of the optical pulse has waveform rounding,
the distance image processing unit
controls the emission timing in the second pattern such that the difference between the flare light reception timing and the first gate opening and closing timing is less than a period corresponding to 1 clock of the clock signal, and
calculates the flare signal amount, by using a subtraction value obtained by subtracting the storage signal in the third pattern from the storage signal in the second pattern, the difference, and a waveform characteristic of the control pulse.

9. A distance image capturing method performed by a distance image capturing device including a light source unit that irradiates an optical pulse to a space to be measured, a light receiving unit having a pixel including a photoelectric conversion element that generates charges according to light incident from the space to be measured and a plurality of charge storage units that store the charges, and a pixel drive circuit that performs driving of storing the charges in each of the charge storage units, and a distance image processing unit that controls the pixel drive circuit such that the charges are distributed to the charge storage units and stored in each of the charge storage units at a storage timing synchronized with an emission timing of emitting the optical pulse, and calculates a distance to an object based on an amount of charges stored in each of the charge storage units, the method comprising:
via the distance image processing unit,
driving the pixel with three driving patterns including a first pattern, a second pattern, and a third pattern;
calculating a flare light reception timing at which flare light is received, based on a storage signal corresponding to the amount of charges stored in each of the charge storage units of the pixel, in the first pattern;
controlling the emission timing such that the flare light reception timing and an opening and closing timing of a first gate for storing the charges in a first charge storage unit among the charge storage units in the pixel are the same timing, in the second pattern;
controlling such that an emission period of emitting the optical pulse is shorter than an emission period in the second pattern, in the third pattern; and
calculating a flare signal amount corresponding to a light amount of the flare light received by the pixel, by using a subtraction value obtained by subtracting the storage signal in the third pattern from the storage signal in the second pattern, to calculate the distance to the object by using the calculated flare signal amount.
